(19) United States
(12) Patent Application Publication
(10) Pub. No.: US 2008/0310823 A1
(43) Pub. Date: Dec. 18, 2008

(54) VIDEO PROCESSING APPARATUS AND CONTROL METHOD THEREOF

(75) Inventor: Heon Jekal, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/106,495

(22) Filed: Apr. 21, 2008

(30) Foreign Application Priority Data
Jun. 18, 2007 (KR) 10-2007-0059639

(51) Int. Cl. H04N 5/93

(52) U.S. Cl. 386/97; 386/E05.028

(57) ABSTRACT

A video processing apparatus, includes: a signal input unit which receives a broadcasting signal; a signal processing unit which processes the broadcasting signal received by the signal input unit; and a control unit which determines whether a virtual channel table which comprises language information exists in additional information which is included in the received broadcasting signal, and, if it is determined that the virtual channel table exists, controls the signal processing unit to process the broadcasting signal based on the language information of a same packet identification in the virtual channel table as a packet identification of a packet which comprises audio information in a program map table which exists in the additional information.

### CROSS-REFERENCE TO RELATED APPLICATIONS

This application claims priority from Korean Patent Application No. 10-2007-0059639, filed on Jun. 18, 2007 in the Korean Intellectual Property Office, the disclosure of which is incorporated herein by reference in its entirety.

### BACKGROUND OF THE INVENTION

1. Field of the Invention

Apparatuses and methods consistent with the present invention relate to processing information about a language of audio information.

2. Description of the Related Art

A display apparatus, such as a monitor and a television, processes and outputs video information and audio information included in a video signal supplied from an external apparatus such as a computer, a digital versatile disc (DVD) player, etc. or provided from a broadcasting station.

In case of processing a broadcasting signal received from the broadcasting station, the video processing apparatus extracts additional information such as a packetized elementary stream (PES), program specific information (PSI), and program and system information protocol (PSIP), and processes the video information and the audio information by using the extracted additional information.

Here, a packet identification (PID) representing the respective positions of a packet in which the video information and a packet in which the audio information are included in the broadcasting signal is included in the additional information. A signal processing module of the video processing apparatus processes the video information and the audio information based on the PID included in the additional information.

ISO 639 language information, which is language information related to a language type of the audio information, is further included in the additional information. Accordingly, when displaying a caption or other on-screen display (OSD), the correct information can be transmitted to a user when the video processing apparatus correctly processes the language information included in the additional information.

Typically, the language information may be included in a program map table (PMT) of the PSI information, and a virtual channel table (VCT) of the PSIP information.

In a related art video processing apparatus, the broadcasting signal is processed by using the PID and the language information of one of the PMT and the VCT depending on an initial setting in manufacturing. However, due to an error of the broadcasting station, if the language information is incorrectly set, or if the language information is included in only one thereof, or is not included therein, the correct information is incapable of being transmitted to the user.

Thus, when the video processing apparatus set to use the PID and the language information in the PMT, if the broadcasting signal having the PMT including incorrect language information is received, information different from the output audio information may be displayed in an OSD.

### SUMMARY OF THE INVENTION

Exemplary embodiments of the present invention address at least the above problems and/or disadvantages and other disadvantages not described above. Also, the present invention is not required to overcome the disadvantages described above, and an exemplary embodiment of the present invention may not overcome any of the problems described above.

The present invention provides a video processing apparatus and a control method thereof using highly reliable language information among the language information included in a virtual channel table and a program map table, thereby informing a user of correct language information.

The present invention also provides a video processing apparatus and a control method thereof for setting a reference related to use of the language information included in a virtual channel table and the language information included in a program map table, thereby minimizing system malfunction.

according to an aspect of the present invention, there is provided a video processing apparatus, including: a signal input unit which receives a broadcasting signal; a signal processing unit which processes the broadcasting signal received by the signal input unit; and a control unit which determines whether a virtual channel table which includes language information in additional information exists which is included in the received broadcasting signal, and, if it is determined that the virtual channel table exists, controls the signal processing unit to process the broadcasting signal based on the language information of a same packet identification in the virtual channel table as a packet identification of a packet which includes audio information in a program map table which exists in the additional information.

If there is a plurality of language information which has a same packet identification as a packet identification confirmed in the program map table in the virtual channel table, the control unit may select one of the plurality of language information based on a predetermined priority order, and processes the broadcasting signal based on the selected language information.

If there is no language information in the virtual channel table, the control unit may display that there is no language information.

If there is not the same packet identification as the packet identification which is confirmed in the program map table in the virtual channel table, the control unit may control the signal processing unit to process the broadcasting signal by using the language information which is included in the program map table.

If it is determined that the virtual channel table does not exist in the additional information which is included in the broadcasting signal, the control unit may control the signal processing unit to process the broadcasting signal based on the language information which is included in the program map table.

If a plurality of audio information is included in a packet identification which is confirmed in the program map table, the control unit may control the signal processing unit to select and process one of the plurality of audio information based on a predetermined priority order.

According to another aspect of the present invention, there is provided a control method of a video processing apparatus, including: receiving a broadcasting signal; determining whether a virtual channel table which includes language information exists in additional information which is included in the received broadcasting signal; confirming a packet identification of a packet which includes audio information in a program map table which exists in the additional information if it is determined that the virtual channel table exists; determining whether there is a same packet identification as the confirmed packet identification in the virtual channel table; and processing the broadcasting signal by using the language information which corresponds to the packet identification if it is determined that there is the same packet identification in the virtual channel table.

The processing the broadcasting signal by using the language information may include: determining whether there is a plurality of language information which has the same packet identification as the packet identification confirmed in the program map table in the virtual channel table, and selecting one of the plurality of language information based on a predetermined priority order, and processing the broadcasting signal based on the selected language information if it is determined that there is the plurality of language information.

If it is determined that language information is not in the virtual channel table, it may be displayed that there is no language information.

The processing the broadcasting signal by using the language information may include processing the broadcasting signal by using the language information which is included in the program map table if it is determined that there is not the same packet identification as the packet identification which is confirmed in the program map table in the virtual channel table.

The processing the broadcasting signal by using the language information may include controlling the signal processing unit to process the broadcasting signal based on the language information which is included in the program map table if it is determined that the virtual channel table does not exist in the additional information.

The processing the broadcasting signal by using the language information may include selecting and processing one of a plurality of audio information based on a predetermined priority order if it is determined that the plurality of audio information is included in the packet identification which is confirmed in the program map table.

### BRIEF DESCRIPTION OF THE DRAWINGS

These and/or other aspects of the present invention will become apparent and more readily appreciated from the following description of the exemplary embodiments, taken in conjunction with the accompanying drawings, in which:

FIG. 1 is a control block diagram of a video processing apparatus according to an exemplary embodiment of the present invention;

FIG. 2 is a flowchart illustrating a control process of the video processing apparatus according to the exemplary embodiment of the present invention;

FIG. 3 is a flowchart illustrating a process of setting language information included in a virtual channel table according to an exemplary embodiment of the present invention;

FIG. 4 is a flowchart illustrating a process of setting language information included in a program map table according to the exemplary embodiment of the present invention; and

FIG. 5 is a flowchart illustrating a process of setting language information included in the program map table according to another exemplary embodiment of the present invention.

### DETAILED DESCRIPTION OF EXEMPLARY EMBODIMENTS OF THE INVENTION

Reference will now be made in detail to the exemplary embodiments of the present invention, examples of which are illustrated in the accompanying drawings, wherein like reference numerals refer to like elements throughout. The exemplary embodiments are described below so as to explain the present invention by referring to the figures.

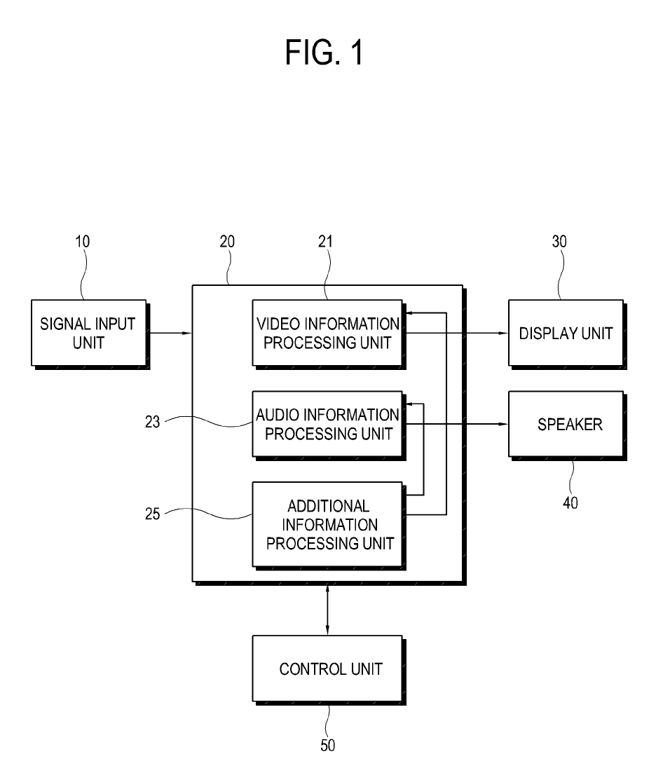

FIG. 1 is a control block diagram of a display apparatus according to an exemplary embodiment of the present invention. As shown in FIG. 1, the display apparatus according to the exemplary embodiment of the present invention includes a signal input unit 10, a signal processing unit 20, a display unit 30, a speaker 40 and a control unit 50.

The signal input unit 10 according the present exemplary embodiment includes a tuner unit (not shown) receiving a broadcasting signal. Here, the tuner unit may include one or more tuners, a demodulator demodulating a tuned signal, etc.

The broadcasting signal having a frequency band corresponding to a tuning control signal of the control unit 50 is tuned. The broadcasting signal of the tuned channel is received in a transport stream type in which video information, audio information and various data are time-division-multiplexed to be packetized.

In case of a digital broadcasting signal, the demodulator outputs the received broadcasting signal in the transport stream type through, for example, but not limited to, a vestigial side band (VSB) demodulating process and/or an error correcting process. The tuner unit may include an analog tuner and/or a digital tuner or a multi-tuner being capable of receiving all of an analog broadcasting signal and a digital broadcasting signal.

The signal processing unit 20 processes and outputs the broadcasting signal input from the signal input unit 10 under control of the control unit 50. As shown in FIG. 1, the signal processing unit 20 according to the present exemplary embodiment includes a video information processing unit 21, an audio information processing unit 23 and an additional information processing unit 25.

The video information processing unit 21 processes the video information included in the broadcasting signal to be displayed on the display unit 30, and may include, for example, but not limited to, a Moving Picture Experts Group 2 (MPEG-2) decoder. The video information processing unit 21 processes the video information based on a PID including video information set by the control unit 50. Here, the PID represents the position of a packet including the video information in the broadcasting signal, and is included in additional information included in the broadcasting signal.

The video information processing unit 21 may be additionally provided with various functions corresponding to a format of the video information. For example, the video information processing unit 21 may include an analog to digital converting function for converting input video information of various formats into a digital video signal of a specific format, a scaling function which receives the digital video information and/or the analog video information to adjust, for example, but not limited to, a vertical frequency, a screen resolution, and/or a screen ratio, to be appropriate for an output standard of the display unit 30, and a predetermined format converting function. Also, the video information processing unit 21 may include a user interface (UI) generating unit (not shown) generating a UI under a control of the control unit 50.

The audio information processing unit 23 processes the audio information included in the broadcasting signal under control of the control unit 50, thereby outputting the processed audio information through a speaker 40. The audio information processing unit 23 may include, for example, but not limited to, an Audio Coding 3 (AC-3) decoder, and an amplifying unit. The audio information processing unit 23 processes the audio information based on the PID including the audio information included in the additional information.

The additional information processing unit 25 extracts and processes the additional information included in the broadcasting signal. The additional information includes, for example, but not limited to, PSI and PSIP.

The display unit 30 displays the video information processed by the video information processing unit 21, and may be provided as one of, for example, but not limited to, a cathode ray tube (CRT), a digital light processing (DLP) display, a liquid crystal display (LCD) and a plasma display panel (PDP). Also, the display unit 30 may be provided as other display types displaying an image.

When there is supplementary information in the additional information, the control unit 50 controls the signal processing unit 20 to process the broadcasting signal by using the language information included in the supplementary information. Also, the control unit 50 may be provided as, for example, but not limited to, a central processing unit (CPU), a microcomputer, and other controlling units known in the art.

When the broadcasting signal is received, the control unit 50 controls the signal processing unit 20 to process the received broadcasting signal. The control unit 50 controls so that the video information, the audio information and the additional information included in the broadcasting signal can be separated and respectively processed.

Also, to process a video signal and an audio signal included in the broadcasting signal, the control unit 50 controls the additional information processing unit 25 to extract and process the additional information. The additional information represents, for example, but not limited to, the PSI and/or the PSIP information. The control unit 50 confirms an identification of a packet including the video signal (PID video), and an identification of a packet including the audio signal (PID-audio) in a PMT of the PSI.

Also, the control unit 50 determines whether there is a VCT having the language information as the supplementary information in the PSIP information among the additional information. The language information exists as an ISO-639_language in a servce_location_descriptor of the VCT.

Since the language information is additionally input at a broadcasting station, the language information included in the VCT has higher reliability than the language information included in the PMT. Accordingly, if there is a VCT in the additional information, the control unit 50 controls the signal processing unit 20 to process by using the language information included in the VCT.

In using the language information included in the VCT, the control unit 50 determines whether there is the same PID in the VCT as the PID_audio confirmed in the PMT. If there is the same PID in the VCT as the PID_audio confirmed in the PMT, the control unit 50 controls the signal processing unit 20 to perform processing by using the language information corresponding to the same PID.

There may not be a single piece of language information but a plurality of language information in the same PID as the PID_audio of the PMT. For example, if the PID_audio of the confirmed PMT is 0x10, and there are three pieces of language information of Korean, English and Spanish in the 0x10 of the VCT, the control unit 50 selects one of the plurality of language information according to a priority order, and sets this to the signal processing unit 20.

The priority order may be set to the factory default, the release nation in which the video processing apparatus is released, the language information positioned at the beginning among a plurality of language information, or the like. The control unit 50 selects one language information based on the priority order.

If there is no language information in the same PID as the PID_audio of the PMT in the VCT, the control unit 50 generates and displays a predetermined OSD to inform a user that there is no language information.

On the other hand, if there is not the same PID as the PID_audio of the PMT in the VCT, the language information included in the PMT is set to the signal processing unit 20.

Also, if there is not the VCT in the additional information, the control unit 50 controls to process the broadcasting signal by using the PID and the language information included in the PMT. In the case of using all of the PID and the language information in the PMT, the control unit 50 controls to process the broadcasting signal by using the language information existing in the same PID as the PID_audio of the PMT.

The control unit 50 may set the PID_audio of the PMT so that the signal processing unit 20 can process the audio information, and may further determine whether a plurality of audio information is included in the PID_audio. If the plurality of audio information is included therein, the control unit 50 selects one of the plurality of audio information based on the priority order, and sets this to the signal processing unit 20. Then, the audio information processing unit 23 processes and outputs the audio information depending on the set PID_audio and the language information.

Accordingly, the user can be informed of the correct language information by using the language information of high reliability among the language information included in the VCT and the PMT. Also, since a reference about which of the language information included in the VCT and the language information included in the PMT to use is set depending on the input broadcasting signal, system malfunction can be minimized.

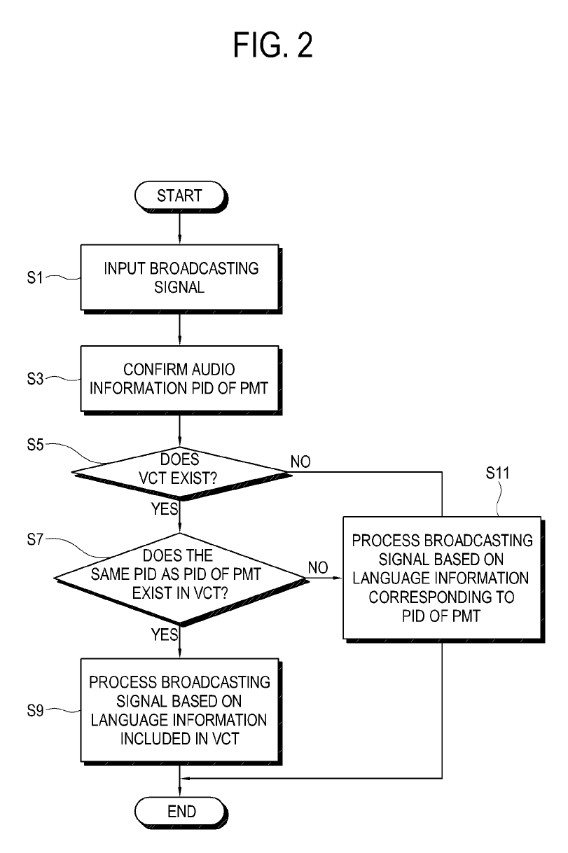

Hereinafter, a control method of the video processing apparatus according to the exemplary embodiment of the present invention will be described by referring to flowcharts in FIGS. 2-5.

As shown in FIG. 2, when the broadcasting signal is input (S1), the PID of the video information and the audio information in the PMT among the additional information included in the broadcasting signal is set to the signal processing unit 20 so that the signal processing unit 20 can process the video information and the audio information (S3).

Then, the control unit 50 determines whether the supplementary information, that is, the VCT, exists in the additional information (S5).

If the control unit 50 determines that the VCT exists in S5, the control unit 50 determines whether there is the same PID in the VCT as the PID confirmed in the PMT (S7).

If the control unit 50 determines that there is the same PID as the PID of the PMT in the VCT in operation S7, the language information corresponding to the PID is set to the signal processing unit 20 so that the signal processing unit 20 can be controlled to process the broadcasting signal by using the set PID and language information (S9).

If the control unit 50 determines that there is not the same PID as the PID of the PMT in the VCT in operation S7, the broadcasting signal is processed by using the language information corresponding to the PID of the PMT (S11).

Similarly, if the control unit 50 determines that the VCT does not exist in the additional information of the broadcasting signal in operation S5, the broadcasting signal is processed by using the language information corresponding to the PID of the PMT (S11).

Accordingly, the user can be informed of the correct language information by using the language information of high reliability among the language information included in the VCT and the PMT. Also, since the reference about which of the language information included in the VCT and the language information included in the PMT to use is set depending on the input broadcasting signal, system malfunction can be minimized.

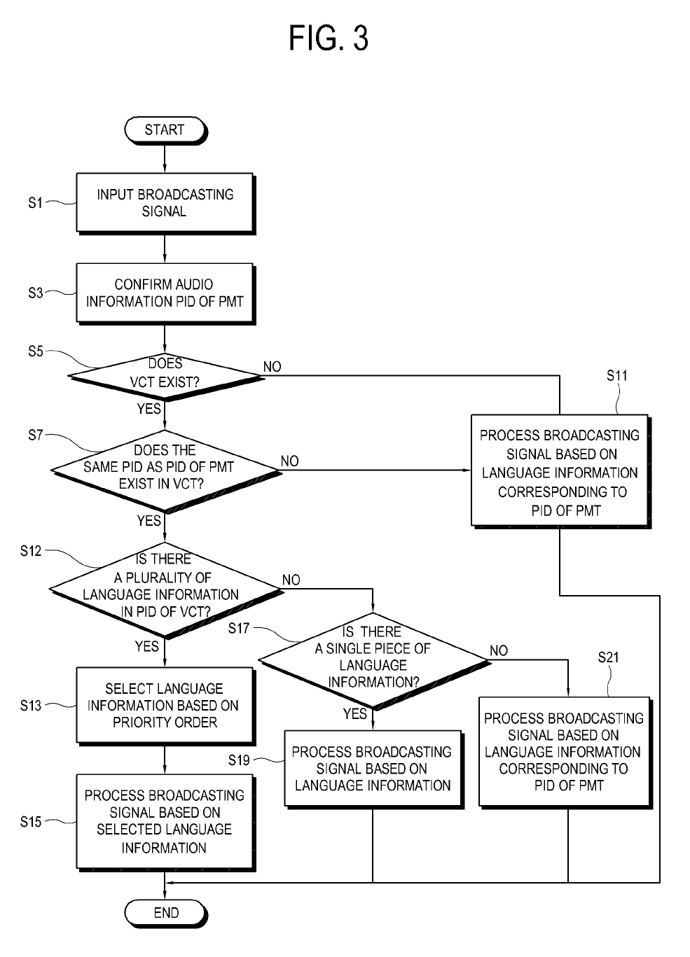

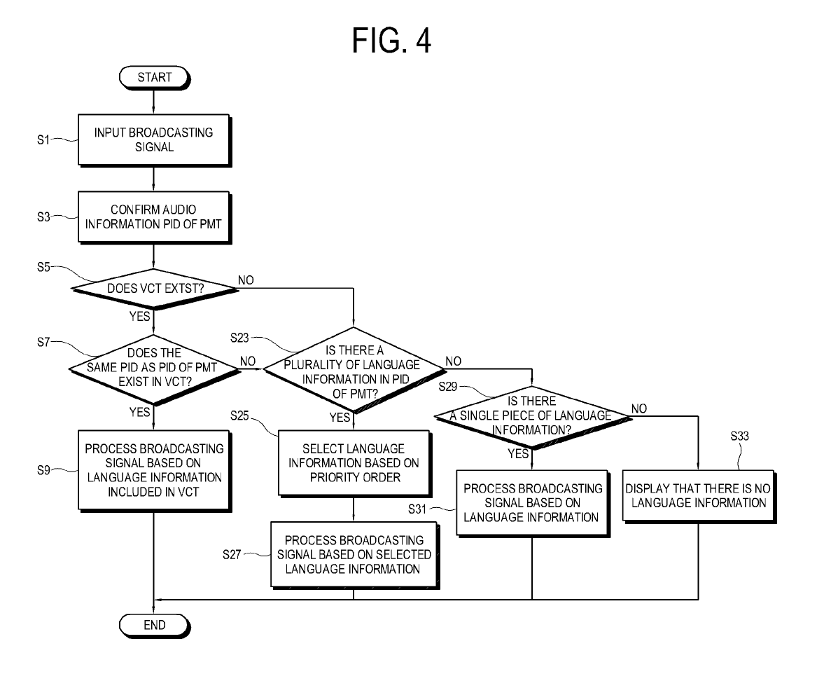

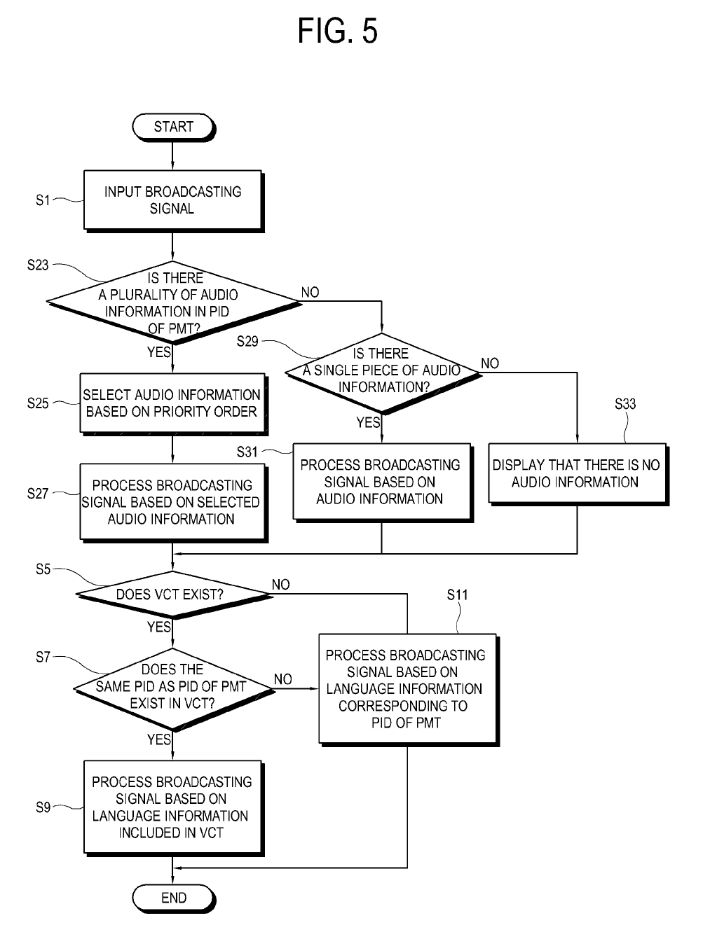

Hereinafter, a control method of a display apparatus according to an exemplary embodiment of the present invention will be described by referring to FIGS. 3 to 5. FIG. 3 illustrates a process of setting language information included in a VCT. FIG. 4 illustrates a process of setting language information included in a PMT. FIG. 5 illustrates another process of setting audio information included in the PMT.

As shown in FIG. 3, if the VCT exists in an input broadcasting signal (S1-S5), and there is the same PID as the PID of the PCT in the VCT (S7), a control unit 50 determines whether there is a plurality of language information included in the PID of the VCT (S12).

If it is determined that the plurality of language information is included in the PID in operation S12, the control unit 50 selects the language information among the plurality of language information based on a predetermined priority order (S13).

As described above, the priority order may be set to, for example, but not limited to, the factory default, the release nation in which the video processing apparatus is released or the language information positioned at the beginning among a plurality of language information. The control unit 50 may select one of the plurality of language information based on the set priority order.

Then, the broadcasting signal is processed based on the selected language information (S15).

If it is determined that the plurality of language information is not included in the PID in operation S12, it is determined whether there is a single piece of language information (S17). If there is the single piece of language information, the language information is set to the signal processing unit 20 to process the broadcasting signal based on the language information (S19).

If it is determined that there is not the single piece of language information in operation S17, the language information is determined not to be included therein, and the broadcasting signal is controlled to be processed by using the language information corresponding to the PID of the PMT based on the language information corresponding to the PID of the PMT (S21).

If the VCT does not exist in the input broadcasting signal, or if there is not the same PID as the PID of the PMT in the VCT (S1-S5), the control unit 50 processes the broadcasting signal based on the language information corresponding to the PID of the PMT (S11).

Alternatively, as shown in FIG. 4, if there the VCT does not exist in the input broadcasting signal, or if there is not the same PID as the PID of the PMT in the VCT (S1-S5), the control unit 50 may determine whether a plurality of audio information is included in the PID of the PMT (S23).

If it is determined that the plurality of audio information is included therein in operation S23, the control unit 50 selects one of the plurality of audio information based on the predetermined priority order (S25), and sets the audio information to the signal processing unit 20 to process the broadcasting signal based on the selected audio information (S27).

If it is determined that the plurality of audio information is not included therein in operation S23, it is determined whether there is a single piece of audio information (S29). If there is the single audio information, the audio information is set to the signal processing unit 20 to process the broadcasting signal based on the single audio information (S31).

If it is determined that there is no audio information in operation S29, it is displayed to a user that there is no audio information (S33).

Further, as shown in FIG. 5, when the broadcasting signal is input (S1), the control unit 50 determines whether a plurality of audio information is included in the audio information PID of the PMT included in the input broadcasting signal (S23).

If it is determined that the plurality of audio information is included therein in operation S23, the control unit 50 selects one of the plurality of audio information based on the predetermined priority order (S25), and sets the audio information to the signal processing unit 20 to process the broadcasting signal based on the selected audio information (S27).

If it is determined that the plurality of audio information is not included therein in operation S23, it is determined whether there is a single piece of audio information (S29). If there is the single piece of audio information, the audio information is set to the signal processing unit 20 to process the broadcasting signal based on the single piece of audio information (S31).

If it is determined that there is no audio information in operation S29, it is displayed to the user that there is no audio information (S33).

Accordingly, the user can be informed of the correct language information by using the language information of high reliability among the language information included in the VCT and the PMT. Also, since the reference about which of the language information included in the VCT and the language information included in the PMT to use is set depending on the input broadcasting signal, system malfunction can be minimized.

Also, if there is a plurality of language information and audio information, the language information and the audio information are selected among the plurality of language information and audio information based on the predetermined priority order, thereby reducing system malfunction.

As described above, exemplary embodiments of the present invention provide a video processing apparatus and a control method thereof using language information of high reliability among language information included in a virtual channel table and a program map table, thereby informing a user of correct language information.

Also, exemplary embodiments of the present invention provide a video processing apparatus and a control method thereof setting a reference about which of language information included in a virtual channel table and language information included in a program map table to use, thereby minimizing system malfunction.

Also, exemplary embodiments of the present invention provide a video processing apparatus and a control method thereof selecting language information and audio information among a plurality of language information and audio information based on a predetermined priority order if there is the plurality of language information and audio information, thereby reducing system malfunction.

Although a few exemplary embodiments of the present invention have been shown and described, it will be appreciated by those skilled in the art that changes may be made in these exemplary embodiments without departing from the principles and spirit of the invention, the scope of which is defined in the appended claims and their equivalents.

What is claimed is:

1. A video processing apparatus comprising:
a signal input unit which receives a broadcasting signal;
a signal processing unit which processes the broadcasting signal received by the signal input unit; and
a control unit which determines whether a virtual channel table which comprises language information exists in additional information which is included in the received broadcasting signal, and, if it is determined that the virtual channel table exists, controls the signal processing unit to process the broadcasting signal based on the language information of a same packet identification in the virtual channel table as a packet identification of a packet which comprises audio information in a program map table which exists in the additional information.

2. The video processing apparatus according to claim 1, wherein, if there is a plurality of language information which has a same packet identification as a packet identification confirmed in the program map table in the virtual channel table, the control unit selects one of the plurality of language information based on a predetermined priority order, and processes the broadcasting signal based on the selected language information.

3. The video processing apparatus according to claim 2, wherein, if there is no language information in the virtual channel table, the control unit displays that there is no language information.

4. The video processing apparatus according to claim 1, wherein, if there is not the same packet identification as the packet identification which is confirmed in the program map table in the virtual channel table, the control unit controls the signal processing unit to process the broadcasting signal by using the language information which is included in the program map table.

5. The video processing apparatus according to claim 1, wherein, if it is determined that the virtual channel table does not exist in the additional information which is included in the broadcasting signal, the control unit controls the signal processing unit to process the broadcasting signal based on the language information which is included in the program map table.

6. The video processing apparatus according to claim 1, wherein, if a plurality of audio information is included in a packet identification which is confirmed in the program map table, the control unit controls the signal processing unit to select and process one of the plurality of audio information based on a predetermined priority order.

7. A control method of a video processing apparatus, the control method comprising:
receiving a broadcasting signal;
determining whether a virtual channel table which comprises language information exists in additional information which is included in the received broadcasting signal;
confirming a packet identification of a packet which comprises audio information in a program map table which exists in the additional information if it is determined that the virtual channel table exists;
determining whether there is a same packet identification as the confirmed packet identification in the virtual channel table; and
processing the broadcasting signal by using the language information which corresponds to the packet identification if it is determined that there is the same packet identification in the virtual channel table.

8. The control method according to claim 7, wherein the processing the broadcasting signal by using the language information comprises:
determining whether there is a plurality of language information which has the same packet identification as the packet identification confirmed in the program map table in the virtual channel table, and
selecting one of the plurality of language information based on a predetermined priority order, and processing the broadcasting signal based on the selected language information if it is determined that there is the plurality of language information.

9. The control method according to claim 8, wherein, if it is determined that language information is not in the virtual channel table, it is displayed that there is no language information.

10. The control method according to claim 7, wherein the processing the broadcasting signal by using the language information comprises processing the broadcasting signal by using the language information which is included in the program map table if it is determined that there is not the same packet identification as the packet identification which is confirmed in the program map table in the virtual channel table.

11. The control method according to claim 7, wherein the processing the broadcasting signal by using the language information comprises controlling the signal processing unit to process the broadcasting signal based on the language information which is included in the program map table if it is determined that the virtual channel table does not exist in the additional information.

12. The control method according to claim 7, wherein the processing the broadcasting signal by using the language information comprises selecting and processing one of a plurality of audio information based on a predetermined priority order if it is determined that the plurality of audio information is included in the packet identification which is confirmed in the program map table.
